(19) United States
(12) Patent Application Publication
(10) Pub. No.: US 2018/0060900 A1
(43) Pub. Date: Mar. 1, 2018

(54) METHOD AND SYSTEM FOR DETERMINING THE ATTENTION OF A USER OF AT LEAST ONE VIDEO ADVERTISING IN A WEB PAGE AND FOR RECYCLING THE VIDEO ADVERTISING DISPLAYED TO THE USER DEPENDING ON SAID MEASUREMENT

(71) Applicant: MEDIABONG, Paris (FR)

(72) Inventors: Laurent Bury, Paris (FR); Pierre Claudon, Vandoeuvre-Les-Nancy (FR); Khalid Mehl, Nanterre (FR)

(73) Assignee: MEDIABONG, Paris (FR)

(21) Appl. No.: 15/396,093

(22) Filed: Dec. 30, 2016

(30) Foreign Application Priority Data
Aug. 26, 2016 (FR) 1657983

(51) Int. Cl. G06Q 30/02; H04L 29/08; H04N 21/81; H04N 21/442; H04N 21/25; H04N 21/2668; H04N 21/262

(52) U.S. Cl. CPC G06Q 30/0242; H04L 67/02; H04L 67/20; G06Q 30/0277; H04N 21/26258; H04N 21/44218; H04N 21/251; H04N 21/2668; H04N 21/812

(57) ABSTRACT

Method for measuring a user's attention to at least one video advertisement in an Internet page,
the Internet page comprising at least one video space suitable for displaying a video advertisement.

The method comprises steps during which:
when a video advertisement is displayed in at least one video space,
events are measured linked to at least one from among the structure of the Internet page comprising the video spaces in which the video advertisement is displayed and the actions of the user,
at least one criterion is determined linked to the events measured,
an attention measurement is then determined according to the values of the criteria.

The technical field of the invention is the broadcasting of video content in Internet pages, and more particularly the broadcasting of video advertisements according to the user's behavior.

Internet sites and applications, notably mobile applications for smartphones comprise documents or pages (usually in HTML format), which are able to combine multiple content types such as texts, images and videos, from both editorial content specific to the site and advertising content generally from third-party providers of video advertisements.

In the particular case of advertising content in the form of videos, this may be inserted manually and statically or dynamically within said pages.

In general, video content is read by means of a video playback program. Currently, such video playback programs most often use a technology known as “streaming” allowing real-time data transfer for displaying the video without requiring the transfer of the entire video before starting its playback.

Advertising systems can be used to display a video advertisement, before, during or after the broadcast of a video content, in the case of an “in-stream” advertisement or without the support of a video content, in the case of an “out-stream” advertisement.

The startup of these video advertisements may be initiated actively by the user, automatically on displaying the page, or activated by the user scrolling through the page.

These video advertisements may be targeted according to various criteria, mainly according to the user's predicted or known characteristics such as their socio-demographic characteristics or history of behavior.

These advertisements may be delivered in a variety of ways: following a static call (call to a third-party Internet page comprising the advertisement from the Internet home page), a dynamic call (call to a third-party Internet page comprising the advertisement including parameters or metadata) or a call in program form (bids in real time for the use of the advertising space).

However, whatever the broadcasting and startup modes selected, video advertisements are currently limited to predefined spaces, which may no longer be in the user's field of vision when scrolling through an Internet page. In such a case, the advertisement that is broadcast to the user is not actually viewed by the latter. This notably results in distorted broadcasting statistics.

Given the growing advertising clutter in Internet pages, the user's attention is becoming a determining variable in the effectiveness of an advertisement.

The document U.S. Pat. No. 9,143,840 is known from the prior art, which describes a measurement of visibility of video advertisements in an Internet page. However, this measurement only takes into consideration two criteria, the visibility of the surface area of the video playback program in the Internet page and the duration during which the video advertisement is actually read. In addition, these criteria are taken into account in a disjointed way in establishing the measurement.

There is a need for measuring a user's attention to a video advertisement which takes into account multiple separate criteria simultaneously.

The subject matter of the invention is a method for measuring the user's attention to at least one video advertisement in an Internet page, the Internet page comprising at least one video space capable of displaying a video advertisement.

The method comprises steps during which:

when a video advertisement is displayed in at least one video space,

events are measured linked to at least one from among the structure of the Internet page comprising the video spaces in which the video advertisement is displayed and the actions of the user,

at least one criterion is determined linked to the events measured,

an attention measurement is then determined according to the values of the criteria.

The measurement of events may be intermittent or periodic at the conclusion of a predetermined time interval.

A criterion may be linked to at least one from among the visibility of the video space in the user's field of view, the ratio between the video space surface area and the total surface area of the screen visible to the user, the absolute position of the video space on the user's active screen, the position of the mouse cursor on the page, the icon clutter in the vicinity of the video space, the user's speed of movement in the page, the user's interactions with the video space, the playback duration of the video advertisement, and the startup mode of the video.

After measuring the events, and before determining at least one criterion, the measurements may be reprocessed in order not to take account of events measured while the video advertisement is not displayed, events measured before the actual startup of the display of the video advertisement, events measured after a maximum duration of display of the video advertisement, events measured in relation to a measurement of the size and position of the video space above a threshold value linked to the size of the page and/or the active screen.

When a first video advertisement is displayed for a first product and for a first brand,

it may be determined whether the measurement of the user's attention is below a first threshold,

if such is the case, the broadcast of the first video advertisement may be interrupted, and it is determined not to offer the first video advertisement again, and the display of another video advertisement is ordered for a brand and a product other than the first product of the first brand,

if such is not the case, it may be determined whether the measurement of the user's attention is below a second threshold above the first threshold,

if such is the case, the display of a second video advertisement may be ordered, different from the first video, for the first product and the first brand,

if such is not the case, the display of a third video advertisement of the first brand may be ordered for a product other than the first product, or for the same product but presenting at least one feature or item of information different from those presented in the first video advertisement.

The results of measuring attention with respect to a product and/or a brand may be retained when the Internet page is changed by the user.

The results of measuring attention with respect to a product and/or a brand may be retained when a new video space broadcasts the video advertisement in the Internet page viewed by the user.

The subject matter of the invention is also a system for measuring a user's attention to at least one video advertisement in an Internet page, the Internet page comprising at least one video space capable of displaying a video advertisement. The system comprises a script included in the Internet page, capable of measuring events linked to at least one from among the structure of the Internet page comprising at least one video space in which the video advertisement is displayed and the actions of the user, a video playback program executed by the user capable of requesting the advertisement to be displayed and ordering the display of the video advertisement in at least one video space in the Internet page, and an advertising platform capable of receiving the requests for video advertisements from the video playback program, sending advertising requests to third-party providers of video advertisements and transmitting a video advertisement or a list of video advertisements to the video playback program according to the information received from the script,

the script and the advertising platform are capable of cooperating in order to determine a measurement of a user's attention according to the events measured by the script.

The system may comprise a container comprising the video advertisement and the script, the container being opened by the video playback program, the script being sent to the Internet browser to be executed, the video advertisement being displayed by the video playback program in at least one video space of the Internet page.

The script may be capable of determining at least one criterion linked to the events measured, and then determining an attention measurement according to the values of these criteria and transmitting it to the advertising platform.

The advertising platform may be capable of determining at least one criterion linked to the events measured by the script, and then determining an attention measurement according to the values of these criteria.

As part of a system for retargeting the video advertisement displayed to the user, the advertising platform may be capable of determining the video advertisement to be displayed according to the comparison of the attention measurement with at least one predetermined threshold.

Other objects, features and advantages of the invention will appear on reading the following description, given solely as a non-restrictive example with reference to the accompanying drawings in which:

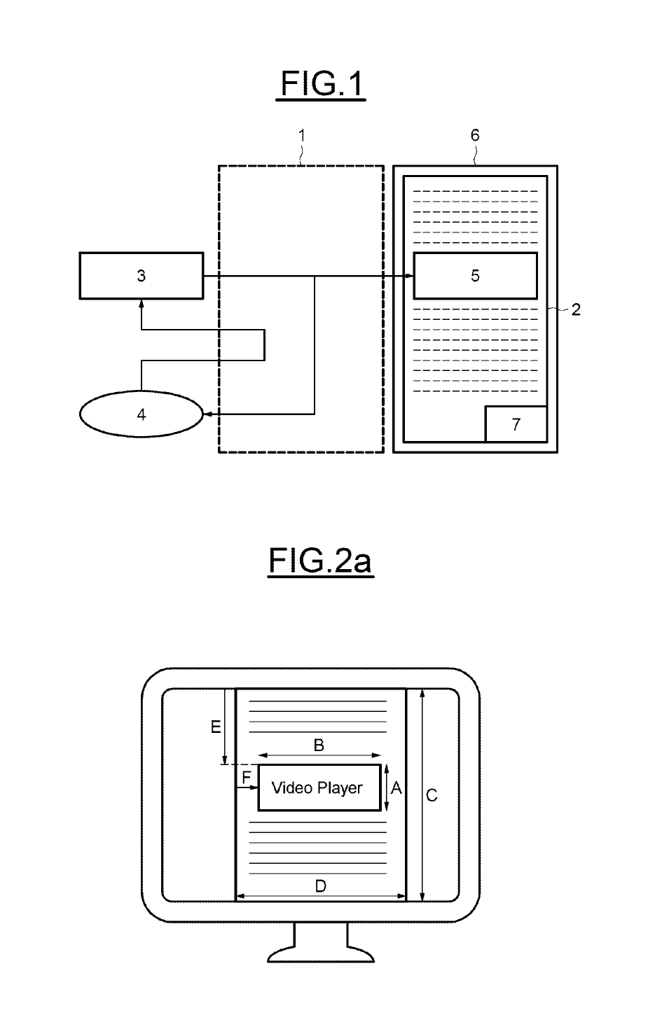

FIG. 1 illustrates the main elements of the system according to the invention,

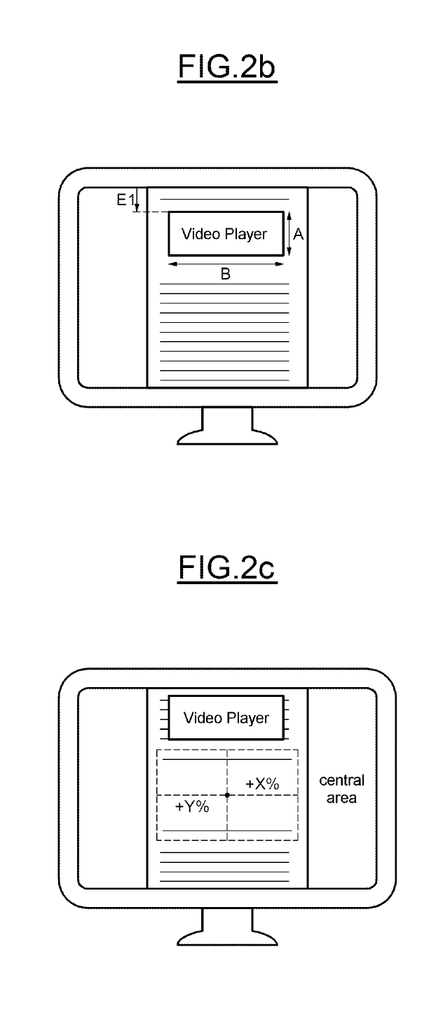

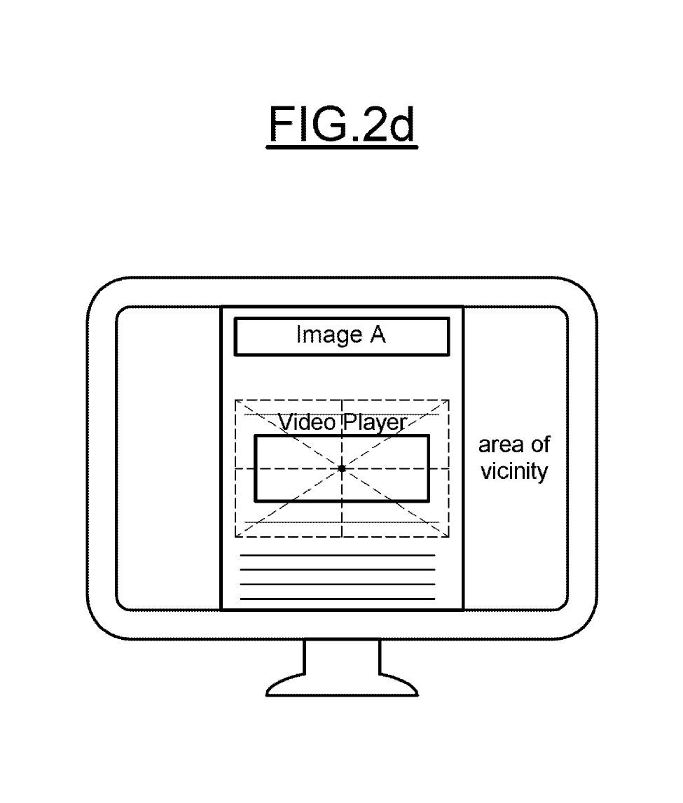

FIGS. 2a and 2b illustrate the main elements of a criterion linked to the visibility of the video space in the user's field of view,

FIG. 2c illustrates the main elements of a criterion linked to the absolute position of the video space on the user's active screen, illustrated in FIG. 2c, and

FIG. 2d illustrates the main elements of a criterion linked to the icon clutter in the vicinity of the video space.

FIG. 1 illustrates the main elements of the system according to the invention. A user, notably a net surfer, connects to a network 1, notably the Internet network by means of a device (such as a computer, a smartphone, a connected television or any other suitable device, etc.). The user then sends an access and display request to an Internet page. They receive in return data allowing the Internet page to be displayed on the device used for connecting to the network, and allowing the user to interact with the page. The alternation of requests and data received in return continues at each new action by the user.

When the called Internet page 2 comprises the method according to the invention, the latter communicates with an advertising platform 3 capable of delivering a video advertisement or of calling upon one or more third-party providers of video advertisements. Where appropriate the platform selects a video advertisement 4 and transmits it to a video playback program 5, included in the Internet page. Said video advertisement 4 is displayed in at least one video space of the Internet page.

The method of measuring attention is executed locally on the user's device 6 via a script 7, or remotely on the advertising platform 3 according to the measurements received from the script, or by a combination of local and remote executions.

The measurement method comprises a first step during which events are measured intermittently or periodically at the conclusion of a predetermined time interval linked to at least one from among the structure of the Internet page comprising the video spaces in which the video advertisement is displayed and the actions of the user. During a second step, at least one criterion is determined linked to the events measured. During a third step, an attention measurement is then determined according to the values taken by these criteria.

A first criterion is linked to the visibility of the video space in the user's field of view, illustrated by FIGS. 2a and 2b.

To achieve this, the user's field of view is determined, the part of the Internet page entering the user's field of view is determined characterized by the length C and the width D of the page display.

The person skilled in the art will understand that the user's field of view is determined by the resolution of the display device combined with the scale or zoom ratio employed. On a computer, the display device is, for example, the screen or a video projector. On a smartphone, it is generally the screen.

The absolute position of the video space on the page is then determined (by its horizontal F and vertical E coordinates). The first criterion is thereby deduced, linked to the ratio of the surface area of the video space entering the field of view and the total surface area of the Internet page visible on the active screen.

This absolute position and the first criterion are recalculated in a loop at regular time intervals, so as to take into account either the movement of the page on the screen as a result of an action by the user (notably scrolling in the page), or a movement of the active video space within the page when a video advertisement is synchronized over multiple video spaces.

A second criterion is linked to the size of the video space on the user's active screen.

The surface area of the video space as well as the total surface area of the screen visible to the user are determined. In the case of a consultation on a mobile device, these variables may be measured at each time interval or at each change in size that would be caused, for example, by the rotation of the screen and the redimensioning of the elements of the page.

The second criterion is linked to the ratio between the surface area of the video space and the total surface area of the screen visible to the user.

A third criterion is linked to the absolute position of the video space on the user's active screen, illustrated in FIG. 2c.

Regardless of its position within the screen, the fact that the video space displays a video advertisement in a central position of the screen, the “attention area”, reinforces the probability of the user's attention. The “attention area” is defined as the area extending from the center of the page, on each side vertically to a first percentage of the total height of the screen, and horizontally to a second percentage of the total width of the page on the screen.

The third criterion is determined as the percentage of the surface area of the video space entering the attention area.

A fourth criterion is linked to the position of the mouse cursor on the page. Indeed, it is considered that a mouse cursor approaching the display area of the video space indicates greater attention by the user. It should be noted that when an Internet page is displayed on a touch device (mobile phone, tablet, touch screen computer), the absence of mouse and cursor leads to ignoring this criterion.

Beginning from the startup of the video advertisement, the position of the cursor on the screen is recorded at a regular time interval, and it is determined whether the latter is nearing the display area of the video space broadcasting the video advertisement.

More precisely, the fourth criterion may be determined as a function decreasing with the distance between the position of the cursor on the screen and the position of the display area of the video space broadcasting the video advertisement.

Furthermore, the cases are ignored where the mouse cursor is positioned outside the Internet page.

A fifth criterion is linked to the icon clutter in the vicinity of the video space illustrated in FIG. 2d.

The presence of other videos, text or images in the vicinity of the video space is likely to disrupt the user's attention. The position and surface area of all the videos or images located in an area extending around the video space is determined, e.g. an area extending over one and a half times the height and width of the display area of the video space.

It is considered that the attention given to the video advertisement drops when there is attractive content around the video space. The user's attention is therefore a decreasing function of the number of attractive elements around the video space and their typologies.

Therefore the type and number of elements (images, texts, videos, etc.) are determined that are located in the area extending around the video space. For example, the number Na of textual elements, the number Nb of icon elements, the number Nc of video elements are determined, then weights Xa, Xb, Xc are assigned to the numbers of elements Na, Nb, Nc with Xc>Xb>Xa.

The fifth criterion is determined as the number of elements divided by the sum of the number of weighted elements.

A sixth criterion is linked to the user's speed of movement in the page. It is considered that a fast movement leading to placing the video space outside the area of visibility indicates a lack of attention with regard to the video advertisement (or even a rejection if this movement has taken place shortly after the startup of the video advertisement).

The speed of movement of the page on the screen is determined by following the change in the absolute position of a reference point of the Internet page at regular time intervals (e.g. every second). This movement in position (in pixels) being essentially vertical (reading the content in the Internet page), this movement may be related to the elapsed time (here in seconds) from the last position tracking so as to define a speed. Then this speed is compared to a threshold so as to determine whether it is a fast speed or a slow speed.

The change in speed of movement of the page is also determined. A unitary movement of the page corresponding to a large movement in a short time disrupts the attention. A continuous movement of the page often demonstrates that attention is on the text.

The sixth criterion is a decreasing function of the number of movements during the display of the video advertisement, their speed and the continuous or unitary nature of these movements.

A seventh criterion is linked to the user's interactions with the video space.

Periodically, at least one of the conditions is determined from among the activation of the sound of the video advertisement in the video space, the closure by the user of the video space, the activation by the user in the video space of a button of the “ignore the advertisement” type allowing the video advertisement to be shortened and the activation by the user of a link in the video content (referring in general to the Internet page of the brand or product) or some of its elements in the case of an enriched video advertisement (e.g. the sharing of the video advertisement on a social network, activation of a textual or graphical element superimposed on the video stream, prompting the user to perform an action, take advantage of an offer, etc.).

These conditions may be classified into two families: strong attention and involvement signals (activation of the sound, activation of a link in the video content or its elements) and weak attention signals (deactivation of the sound, closure of the video space or activation in the video space of a button of the “ignore the advertisement” type).

The seventh criterion is an increasing function linked to the duration of display of the video advertisement with the sound active. In contrast, the seventh criterion does not vary during the display of the video advertisement with the sound inactive.

The closure of the video space or the activation in the video space of a button of the “ignore the advertisement” type indicates weak attention given to the video advertisement on the part of the net surfer, which reduces the value of the seventh criterion.

The activation of a link in the video content or one of its elements indicates that the video has captured the attention of the net surfer, which increases the value of the seventh criterion.

The seventh criterion is determined according to the duration of display of the video advertisement with the sound active or inactive, the closure of the video space or the activation in the video space of a button of the “ignore the advertisement” type and the activation of a link in the video content or one of its elements.

An eighth criterion is linked to the playback duration of the video advertisement.

The playback status of the video advertisement is measured at each time interval (in playback or pause).

In one embodiment, this data is collected via an event provided by a video playback program. For example, it is known that video playback programs employed for advertising purposes generate an event when the video starts, reaching 25%, 50%, 75% and 100% of its total duration via the VAST & VPAID standards.

When the standard or the video playback program does not return more precise information than this event per quartile of duration, the measurement may be refined by retaining a “frame” (or image forming part of the video stream) at each time interval, then by comparing, a “frame” from instant t and a “frame” from instant t+1 and by determining whether they are identical or different. If the “frames” are different, it is concluded that the video playback has progressed.

It is to be noted that the first seconds of broadcasting of the video advertisement are often experienced by the user since the video advertisement may start without their requesting it. The contribution of the events collected during the first seconds is given less weight than the contribution of the following time intervals.

A different weight may then be assigned to each time interval according to the behavior of the net surfer, the advertising format, the startup mode or the video advertisement.

The eighth criterion varies as an increasing weighted function dependent on the elapsed playback duration, the weighting increasing with the elapsed duration.

A ninth criterion is linked to the startup mode of the video.

The startup mode of the video advertisement is determined. The following are examples of startups: startup of the video advertisement initiated by the user by clicking on the video space, by passing their mouse over the video space or automatic startup as soon as the video space is displayed in the Internet page, or as soon as the movement of the Internet page on the screen makes the video space visible.

The ninth criterion is determined according to the interaction of the user with the video space. A greater interaction (e.g. a click on the video space) is associated with a greater value of the ninth criterion. By contrast, a lesser interaction (e.g. an automatic startup of the video advertisement) is associated with a lesser value of the ninth criterion. Among the video advertisement startup modes commonly employed, may be cited, in order of decreasing interaction, a startup on clicking, a startup on the mouse cursor passing over the video space, and an automatic startup.

The ninth criterion is taken into account in determining the attention measurement as a weighting coefficient affecting all the other criteria.

After the criteria are determined, the measurements are reprocessed.

The events measured while the video playback program is paused or inactive (since visibility no longer has any meaning) or as soon as the video advertisement has been closed or “zapped” are eliminated from the events taken into account in determining the criteria and the attention measurement.

Also eliminated are the events measured after a maximum duration of display of the video advertisement. The maximum duration of display may correspond to the total duration of the video advertisement or to a predefined duration when the video playback program is not capable of communicating the total duration of the video advertisement to the measurement script.

More particularly, in the case where it is not the video playback program that initializes the collection script, the visibility measurements that may take place prior to the actual startup of the display of the video advertisement are eliminated. In the case where the video playback program does not return an end of playback event (video viewed until the end), and where the total duration of the video is unknown, it is considered that the duration of display may not exceed a ceiling (e.g. 30 seconds, which is the duration of the majority of video advertisements) and the events recorded after this ceiling duration are deleted.

The total duration of the video advertisement (in the case where the latter is not communicated to the script) is deduced on the basis of the playback time that has actually elapsed when the 25% playback event is sent by the video playback program.

It is ensured that the measurement of the size and the position of the video space is compatible with the size of the page and the active screen (e.g. the size of the video space does not exceed 80% of the size of the page), and that the video space is not displayed on the page via a module the status of which would be hidden. If the conditions are not met, the method is interrupted.

The method calculates an incremental attention measurement that is updated as the video advertisement progresses by combining (sum, average, etc.) the values of the various criteria determined at each time interval for obtaining the final attention measurement.

Alternatively, a final attention measurement is calculated at the end of the video (or closure) by combining (sum, average, etc.) the values of the various criteria determined at the conclusion of the playback of the video advertisement (or its closure).

The method described above may be executed locally on the user's device, remotely on servers remote from the user's device, located, for example, in the advertising platform, or by a combination of local and remote executions.

A system for measuring a user's attention to at least one video advertisement in an Internet page comprises an advertising platform, a script and a video playback program capable of displaying the video advertisement in the Internet page.

The video playback program is executed on the user's device through an Internet browser displaying the Internet page. The video playback program is capable of requesting the advertisement to be displayed from the advertising platform or a third party and to order the display of the video advertisement in the Internet page.

The video playback program comprises a component that can be used to manage the metadata and parameters of the advertisements (and may therefore notably be compatible with the commonly used VPAID standard).

The format of the video file may notably be MPEG4, H26x, Flash, HLS, etc. The format is limited only by the programming of the video playback program.

The advertising platform is a piece of software arranged on a remote server (or distributed over multiple servers for reasons of response time and/or performance) and accessible via a network, notably the Internet network.

The advertising platform may where appropriate provide a parameterization of the criteria to be measured in the collection script. It retrieves the data from the collection script according to the defined time interval, and may where appropriate, either execute the method for measuring attention, or receive the attention measurement sent by the method for measuring attention executed by the script on the user's device.

The “script” is developed in a programming language compatible with the Internet page with which it cooperates, and with the browser running on the user's device displaying the Internet page. The programming language may be, for example, Javascript, Objective-C, or Java.

The script is either inserted into the source code of the Internet page, or incorporated in a container comprising the video advertisement to be displayed. The container is openable and opened by the video playback program that reads the video advertisement and sends the script to the browser that executes it.

The script measures the events for determining the various criteria employed by the algorithm in determining the attention measurement. These measurements are made at regular time intervals (e.g. every second).

In one embodiment, the script transmits the events measured to the advertising platform.

In an alternative embodiment, the script is also capable of determining the attention measurement by applying the method for measuring attention according to the events measured, then transmitting the determined attention measurement to the advertising platform.

The script may be present in the Internet page or executed via a container comprising the video advertisement and opened by the video playback program.

More precisely, in one embodiment, the video playback program, at its initialization, makes a request to the platform which transmits the request to one or more advertising providers, receives the advertisement, encapsulates it in a container also including the collection script (following the VPAID standard, for example). The platform returns the address of the container to the video playback program, rather than that of the video advertisement to be broadcast, and once initiated by the player, the container launches the video advertisement and the collection script.

In another embodiment, the collection script is placed directly in the Internet page. The video advertisement is provided directly by the advertising provider to the video playback program.

A method for retargeting the video advertisement displayed to the user according to the attention measurement will now be described. A method for retargeting the video advertisement displayed to the user may be executed locally on the user's computer in the Internet page or requested on one or more remote servers. The method for retargeting the video advertisement displayed to the user determines, according to the attention measurement, the next advertisement to be broadcast to the user, and transmits the parameters of this video advertisement to the video playback program or to the advertising platform.

The method for redirecting attention comprises the following steps.

The scenarios are determined for broadcasting an alternative advertisement according to the measurement of attention in real time to the first advertisement displayed for a first product of a first brand, for the purpose of optimizing the performance of the video advertisement and limiting the intrusiveness perceived by users in broadcasting advertisements to them that do not interest them. Note that product means tangible and intangible products such as services, and brand means companies or individuals offering at least one product for sale or lease.

If the user's attention measurement is below a first threshold, it is concluded that they do not wish to see the first video advertisement. The broadcasting of the first advertisement is stopped (closure of the video space or display of a new video advertisement) and it is determined not to offer the first video advertisement again.

If the user's attention measurement is above the first threshold but below a second threshold, it is thereby deduced that the user shows “average” attention. The display of a second video advertisement is ordered, a variation of the advertisement broadcast at the time of the attention measurement concerning the same product and the same brand. The second video advertisement may be, for example, similar to the first video advertisement but including a promotional offer or an incentive text to discover the offer, or a different video for the same brand on another product.

If the user's attention measurement is above the second threshold, it determined that the user shows very good attention. The display is then ordered of a third video advertisement of the same brand but for another product, or of the same product but presenting a different feature or new information from that presented in the first video advertisement.

The second video advertisement or the third video advertisement may replace the first advertisement in real time (via the new parameters sent by the retargeting method to the video playback program or to the advertising platform). The playback of the video advertisement may continue in a second space of the page, or in the next visited page.

The results of the comparisons with the first threshold and the second threshold may be retained for the remainder of the user's Internet browsing for Internet pages capable of interacting with the attention measurement method and with the attention redirection method.

1. Method for measuring a user's attention to at least one video advertisement in an Internet page,
the web page comprising at least one video space suitable for displaying a video advertisement,
characterized by the fact that it comprises steps during which:
when a video advertisement is displayed in at least one video space,
events are measured linked to at least one from among the structure of the Internet page comprising the video spaces in which the video advertisement is displayed and the actions of the user,
at least one criterion is determined linked to the events measured,
an attention measurement is then determined according to the values of the criteria.

2. Method according to claim 1, in which the measurement of events is intermittent or periodic at the conclusion of a predetermined time interval.

3. Method according to claim 1, in which a criterion is linked to at least one from among the visibility of the video space in the user's field of view, the ratio between the video space surface area and the total surface area of the screen visible to the user, the absolute position of the video space on the user's active screen, the position of the mouse cursor on the page, the icon clutter in the vicinity of the video space, the user's speed of movement in the page, the user's interactions with the video space, the playback duration of the video advertisement, and the startup mode of the video.

4. Method according to claim 1, in which, after measuring the events, and before determining at least one criterion, the measurements are reprocessed in order not to take account of events measured while the video advertisement is not displayed, events measured before the actual startup of the display of the video advertisement, events measured after a maximum duration of display of the video advertisement, events measured in relation to a measurement of the size and position of the video space above a threshold value linked to the size of the page and/or the active screen.

5. Method for retargeting the video advertisement displayed to the user according to claim 1, in which, when a first video advertisement is displayed for a first product and for a first brand,
it is determined whether the measurement of the user's attention is below a first threshold,
if such is the case, the broadcast of the first video advertisement is interrupted, and it is determined not to offer the first video advertisement video again, and the display of another video advertisement is ordered for a brand and a product other than the first product of the first brand,
if such is not the case, it is determined whether the measurement of the user's attention is below a second threshold above the first threshold,
if such is the case, the display of a second video advertisement is ordered, different from the first video, for the first product and the first brand,
if such is not the case, the display of a third video advertisement of the first brand is ordered for a product other than the first product, or for the same product but presenting at least one feature or item of information different from those presented in the first video advertisement.

6. Method according to claim 5, in which the results of measuring attention with respect to a product and/or a brand are retained when the Internet page is changed by the user.

7. Method according to claim 5, in which the results of measuring attention with respect to a product and/or a brand are retained when a new video space broadcasts the video advertisement in the Internet page viewed by the user.

8. System for measuring a user's attention to at least one video advertisement in an Internet page, the Internet page comprising at least one video space capable of displaying a video advertisement,
characterized by the fact that it comprises
a script included in the Internet page, capable of measuring events linked to at least one from among the structure of the Internet page comprising at least one video space in which the video advertisement is displayed and the actions of the user,
a video playback program executed by the user capable of requesting the advertisement to be displayed and ordering the display of the video advertisement in at least one video space of the Internet page,
an advertising platform capable of receiving the requests for video advertisements from the video playback program, sending advertising requests to third-party providers of video advertisements and transmitting a video advertisement or a list of video advertisements to the video playback program according to the information received from the script,
the script and the advertising platform are capable of cooperating in order to determine a measurement of a user's attention according to the events measured by the script.

9. Measuring system according to claim 8, comprising a container comprising the video advertisement and the script, the container being opened by the video playback program,
the script being sent to the Internet browser for being executed, the video advertisement being displayed by the video playback program in at least one video space of the Internet page.

10. Measuring system according to claim 8, in which the script is capable of determining at least one criterion linked to the events measured, and then determining an attention measurement according to the values of these criteria and transmitting it to the advertising platform.

11. Measuring system according to claim 8, in which the advertising platform is capable of determining at least one criterion linked to the events measured by the script, and then determining an attention measurement according to the values of these criteria.

12. System for retargeting the video advertisement displayed to the user according to claim 8, in which the advertising platform is capable of determining the video advertisement to be displayed according to the comparison of the attention measurement with at least one predetermined threshold.
